(19) United States
(12) Patent Application Publication
(10) Pub. No.: US 2011/0223361 A1
(43) Pub. Date: Sep. 15, 2011

(54) DECORATIVE ELEMENT FOR WATER FITTINGS AND METHOD FOR PRODUCING SAID DECORATIVE ELEMENT FOR WATER FITTINGS

(76) Inventors: Rudolf Paternoster, Rinchnach (DE); Xaver Pledl, Zwiesel (DE)

(21) Appl. No.: 12/998,716

(22) PCT Filed: Nov. 20, 2009
(86) PCT No.: PCT/EP2009/008263

§ 371 Date: May 24, 2011

(30) Foreign Application Priority Data
Dec. 19, 2008 (DE) 10 2008 064 547.8

(51) Int. Cl. B32B 1/08; E03C 1/00; B27N 5/02; B28B 1/14

(52) U.S. Cl. 428/34.1; 264/109; 264/299

(57) ABSTRACT

The invention relates to a decorative element (10, 12) for water fittings, comprising a sleeve-type section which is produced of plastic, the decorative element (10, 12) for water fittings being placed on the water fitting (1) via said section. The decorative element is characterized in that the sleeve-type section is produced of a composite material including a cured polymer binder (16) and a particulate filler (18) incorporated thereinto. The invention also relates to a method for producing a decorative element (10, 12) for water fittings.

The invention relates to a decorative element for water fittings with a sleeve-type section which is produced from filled plastic, and with which the decorative element for water fittings can be slipped onto the water fitting, as well as a method for producing said decorative element for water fittings.

EP 0 386 594 B1 discloses a sanitary water tap with a decorative sleeve made of plastic. The known decorative sleeve is finished by chrome plating or enamel coating in order to be able to produce water taps in multicolor execution.

DE 100 59 212 A1 discloses a shower holding device with a bracket which can be attached to a building wall or to a wall bar and on which there is a holding element with the capacity to pivot around an axis, the holding element having at least one friction surface which is pressed at least by an adjustable spring element against at least one surface which is held in a rotationally fixed manner on the bracket.

DE 100 27 213 A1 discloses a method for producing a ring-shaped article, in particular a method for producing valve seats by thermal spraying.

DE 39 07 894 A1 discloses a water tap with a hose line for water supply, a handle being provided on whose one end region the hose line can be connected and on whose other end a water discharge mouthpiece is provided, for improvement and especially for variable configuration of the handle it being proposed that the handle be made as a sleeve.

WO 2008/043487 A1 discloses radical cold curing of synthetic resins based on modified poly(meth)acrylates with reactive ethylenic groups.

The object of the invention is to provide a decorative element for water fittings having very good performance characteristics with high aesthetic quality, as well as a pertinent production method which yields said decorative elements for water fittings.

This object is achieved by the decorative element for water fittings which is specified in claim 1 and the production method which is defined in the independent claim. Special embodiments of the invention are defined in the dependent claims.

The sleeve-type section of the decorative element according to the invention for water fittings is produced from a composite material. The composite material has a cured polymer binder, for example, from the group of polyesters, poly(meth)acrylates, polyurethanes, or epoxides, with a particulate filler incorporated thereinto. The decorative element for water fittings, in addition to the sleeve-type section, can have still further sections, in particular can have integrally or in several parts two or more sleeve-type sections which can be arranged in succession or in a slanted position to one another. In one embodiment, the decorative element for water fittings is formed solely by the sleeve-type section.

The particulate filler can be incorporated in the polymer binder more or less uniformly distributed. In one embodiment, in the region of the sleeve-type section, on one outer side which forms the visible side when in use, the particulate filler can be incorporated in the same or higher concentration than on an inner jacket surface which, when in use, forms a rear side which is generally not visible. This ensures that on the visible side both the aesthetic impression and also the performance characteristics of the sleeve-type section are determined largely by the particulate filler. In one embodiment, the wall thickness of the sleeve-type section is greater than or equal to 1 mm, preferably greater than or equal to 2 mm. In one embodiment, the wall thickness is between 2 and 5 mm.

The chrome plating or enamel coatings required in the known decorative sleeves require additional production steps with the corresponding costs which can be eliminated in the inventive decorative element for water fittings. Moreover, the susceptibility to scratches and other damage to the surface design caused by use is prevented or at least dramatically reduced. Furthermore, it is possible to match the optical appearance of the inventive decorative element for water fittings to the appearance of the composite sinks and composite basins which are now widely available or even to bring them into correspondence; this is not possible with enamel coatings.

In one embodiment, the binder is at least in part a cured acrylic resin, in particular polymethyl methacrylate (PMMA). By using acrylic resin, very good performance characteristics can be implemented, especially a surface which is relatively hard and scratch proof for polymer binders and, moreover, a high degree of design freedom with respect to aesthetic color appearance.

The proportion of PMMA in the binder can be at least 50%. In one embodiment, the binder consists at least 90% of PMMA. The binder in the cured state can be colorless and transparent. In one embodiment, color pigments and/or effect pigments are added to the binder so that the cured binder has its own color or a definable optical effect, for example, a metallic effect, regardless of the particulate filler.

The decorative element for water fittings can be thermally deformable to a specified extent. Thus, the material of the decorative element for water fittings can be thermoplastically deformable in plate form up to a minimum bending radius which is equal to twice the plate thickness. Surface treatment of the inventive decorative element for water fittings is possible with the standard method which is known from natural stone treatments.

In one embodiment, at least part of the filler has a greater hardness than the binder. The filler can be especially mineral particles. The particles can be at least in part, particularly with a proportion of at least 50% by weight, unbroken filler grains, as originate, for example, from natural deposits. The fillers are preferably inorganic and have a Mohs hardness of at least 5, such as, for example, aluminum trihydroxide, or even a Mohs hardness of at least 7, such as quartz or, more generally, silicon dioxide (SiO₂).

In one embodiment, the proportion of the filler is between 50 and 95% by weight relative to the mass of the sleeve-type section or of the decorative element for water fittings, preferably between 60 and 80% by weight. In one embodiment, at least 95% by weight of the filler, relative to the mass of all the filler, exhibit a particle size between 0.001 and 5 mm; especially at least 80% by weight have a particle size between 0.01 and 1 mm. In one embodiment, at least 80%, preferably at least 90%, have a maximum particle size of 0.8 mm. In this way, a homogenous distribution of filler particles can be ensured in comparatively thin-walled sleeve-type sections.

In one embodiment, at least part of the filler has a color which differs from the color of the binder. It can be the natural color of the filler particles, and/or at least part of the filler can have a color coating on the surface. The combination of the colorless or colored binder with a particulate filler which likewise has its natural color can yield a non-uniform and thus dirt-resistant color appearance at least on the outside of the sleeve-type section. The particulate filler which has a higher hardness than the binder can moreover increase the resistivity of the sleeve-type section, especially the scratch resistance and wear resistance.

The composite material exhibits lower heat transfer than natural stone, especially lower heat transfer than natural granite. This causes the decorative element for water fittings, especially the sleeve-type section, to be heat-insulating so that, for example, the temperature on the outside of the sleeve-type section remains low even when very hot water is being delivered. Upon contact with the skin, the decorative element for water fittings feels warm even at room temperature; this results in a pleasant surface feel.

In one embodiment, the surface of the sleeve-type section is formed by the composite material. By using different colors for both the binder and the filler, optionally also by means of differently colored fillers, the color appearance of the decorative element for water fittings can be adjusted almost at will, without requiring surface coating or enameling. This improves the performance characteristics because in particular scratching of the enameling or chrome plating cannot occur because the sleeve-shaped section and preferably also the decorative element for water fittings is made of a solid material and thus has no cover layer. The decorative element for water fittings does not have a cover layer which is applied after the production process, in particular after a casting mold process.

In one embodiment, the sleeve-type section is produced as a cast part. In particular, a reaction casting method can be used for this purpose, for example, with thermally induced polymerization of a binder which is present in the initial state as a monomer or monomer/polymer mixture. In one embodiment, the surface of the sleeve-type section is at least partially formed, preferably blanketed on the outside, by a cast skin which is formed by the cured binder. This yields a surface which is easy to clean.

In one embodiment, the surface of the sleeve-type section is formed at least in part by the particulate filler. The filler particles emerge from the binder onto the surface. In one embodiment, more than 20%, preferably more than 30%, and especially more than 40% of the surface of the sleeve-type section, in particular of the cylindrical outer jacket surface, can be formed by the particulate filler. In this way, the hardness and thus the scratch resistance of the surface can be increased.

In one embodiment, the decorative element for water fittings in the sleeve-type section has an outer peripheral surface without gaps and joints. The outer peripheral surface is preferably a cylindrical, in particular circularly cylindrical, jacket surface. On the one hand, this reduces the risk of injury during cleaning, and, on the other hand, the ease of cleaning is improved overall, because dirt pockets cannot form.

In one embodiment, the decorative element for water fittings on the visible side has a surface structure by the cured binder forming slight depressions between the mineral filler particles. The ratio of the distance of two adjacent local peaks or valleys of the surface which are formed by the filler particles and the depth of the depression which extends between two local peaks or valleys is between 50:1 and 2:1.

In one embodiment, the proportion of the filler by weight in the sleeve-type section is more or less constant in the peripheral direction, in particular, it varies from a first one-eighth of a segment to a second one-eighth of a segment which is adjacent in the peripheral direction by less than 10%, preferably by less than 5%, and especially by less than 3%. In the radial direction, there can be a significant variation of the filler proportion, especially such that on the outside the proportion of filler is higher than on the side of the sleeve-type section toward the interior. For example, the proportion of filler particles in the radially outer sleeve half can be higher by more than 2%, especially by more than 4%, than in the radially inner sleeve half.

In one embodiment, the sleeve-type section has an opening for the passage of part of the water fitting, in particular for the passage of an actuating element of the water fitting. The opening can have an oblong shape, and the longitudinal axis of the opening can extend parallel or at a right angle to the longitudinal axis of the sleeve-type section. In one embodiment, the opening has a closed edge line.

The invention also relates to a method for producing a decorative element for water fittings with a sleeve-type section which is produced from a plastic, and with which the decorative element for water fittings can be slipped onto the water fitting. The sleeve-type section is produced here by curing of a polymer binder with a particulate filler of composite material which is incorporated thereinto.

Other advantages, features, and details of the invention will become apparent from the dependent claims and the following description in which several exemplary embodiments are detailed with reference to the drawings. The features referred to in the claims and in the description are essential for the invention each individually or in any combination thereof.

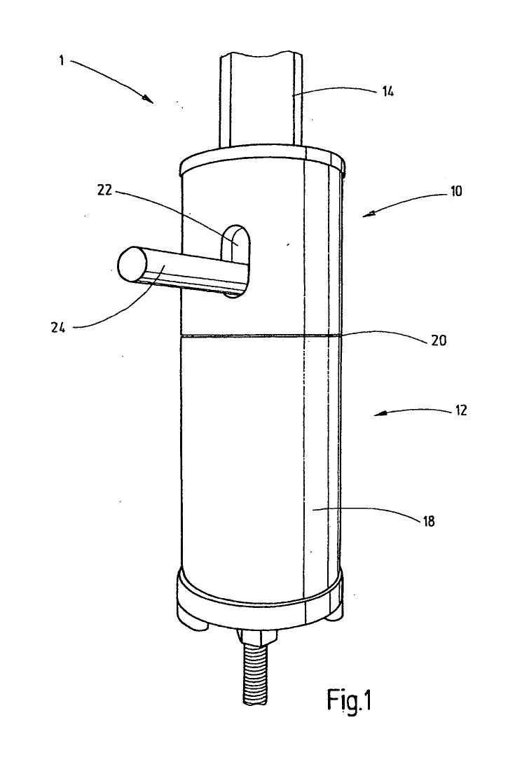

FIG. 1 shows a perspective view of a water fitting shown only partially with the inventive decorative elements for water fittings, and

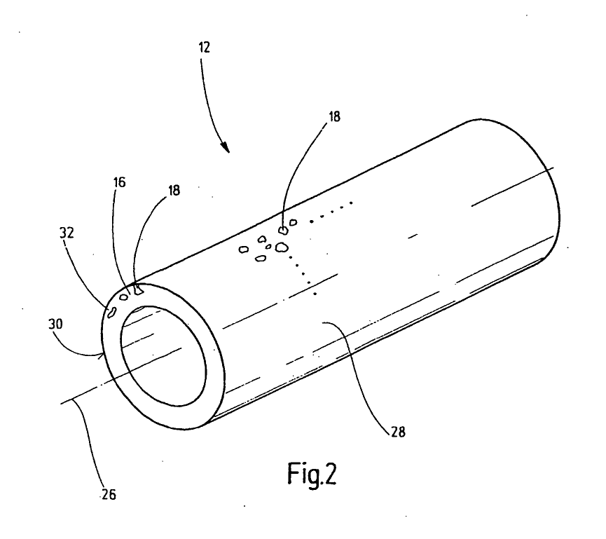

FIG. 2 shows a perspective view of another decorative element for water fittings.

FIG. 1 shows a perspective view of a water fitting 1 which is shown only partially, in particular a water tap with two decorative elements 10, 12 for water fittings according to the invention, which for their part are formed only by a sleeve-type section and which can be slipped onto a cylindrical section 14 of the water fitting 1.

The decorative elements 10, 12 for water fittings are produced from a composite material with a cured polymer binder 16 (FIG. 2) and a particulate filler 18 incorporated thereinto. The decorative elements 10, 12 for water fittings are arranged axially in succession in the direction of a longitudinal axis of the cylindrical section 14 and in particular flush with one another.

The decorative element 10 for water fittings with the smaller axial extension has an oblong opening 22 for passage of an actuating element 24 of the water fitting 1. The opening 22 extends parallel to the longitudinal axis 26 of the decorative element 10 for water fittings.

FIG. 2 shows a perspective view of the decorative element 12 for water fittings which has a hollow cylindrical shape with a circular ring-shaped cross-sectional contour. The length in the direction of the longitudinal axis 26 in the exemplary embodiment is 100 mm, and the wall thickness is 3 mm. The outer peripheral surface 28 is not machined and is specifically such as is formed by the production process, for example, a casting mold process. It is recognizable on the face side that the surface 30 is formed by a cast skin 32 which is formed by the cured binder 16. The particulate fillers 18, in contrast, are spaced apart from the surface 30. In one alternative exemplary embodiment, the particles of the filler 18 can form at least part of the surface 30 of the outer peripheral surface 28.

The decorative element 10, 12 for water fittings can have different fillers 18 which can differ with respect to the material, the size, the shape, and/or the color. In the illustrated exemplary embodiment, the fillers 18 differ especially with respect to their size and color so that the decorative element 10, 12 for water fittings has the optical appearance of granite.

One preferred composition of the decorative element 10, 12 for water fittings consists of 60 to 80% by weight crystalline quartz sand, 80% of the filler 18 having a particle size between 0.05 and 1.2 mm, and of 20 to 40% of a solution of polymethyl methacrylate in methyl methacrylate as the binder 16, the proportion of the polymethyl methacrylate in this solution being between 10 and 30%. Basically all minerals are suitable as the filler 18. To the extent the hardness of the decorative element 10, 12 for water fittings is to be increased by the filler 18, fillers 18 are preferred whose hardness is greater than that of the binder 16.

Furthermore, a peroxide catalyst can be added in an amount between 0.5 and 2% by weight relative to the binder resin as well as 0.1 to 1% of an adhesive which can be present as a coating on the filler 18. Furthermore, a cross-linking agent can be added.

In the illustrated exemplary embodiments, the decorative element 10, 12 for water fittings is made in the shape of a sleeve so that the decorative element 10, 12 for water fittings, in addition to the sleeve-type section, does not have any further sections. Alternatively, the decorative element 10, 12 for water fittings, in addition to a sleeve-type section, optionally can also have sleeve-type sections which, depending on the shape of the water fitting 1, can be arranged in succession or obliquely to one another and abutting one another or spaced apart from one another.

1. A decorative element (10, 12) for water fittings with a sleeve-type section which is produced from plastic, and with which the decorative element (10, 12) for water fittings can be slipped onto the water fitting (1), characterized in that the sleeve-type section is produced from a composite material with a cured polymer binder (16) and a particulate filler (18) incorporated thereinto.

2. The decorative element (10, 12) for water fittings according to claim 1, characterized in that the surface (30) of the sleeve-type section is formed by the composite material.

3. The decorative element (10, 12) for water fittings according to claim 1, characterized in that the proportion of the filler (18) is between 50 and 95% by weight, preferably between 60 an 80% by weight, relative to the mass of the sleeve-type section.

4. The decorative element (10, 12) for water fittings according to claim 1, characterized in that at least 95% by weight of the filler (18) have a particle size between 0.001 and 5 mm, especially at least 80% by weight have a particle size between 0.01 and 1 mm.

5. The decorative element (10, 12) for water fittings according to claim 1, characterized in that at least part of the filler (18) has a greater hardness than the binder (16).

6. The decorative element (10, 12) for water fittings according to claim 1, characterized in that at least part of the filler (18) has a Mohs hardness of at least 5, especially at least 7.

7. The decorative element (10, 12) for water fittings according to claim 1, characterized in that the binder (16) is at least in part a cured acrylic resin.

8. The decorative element (10, 12) for water fittings according to claim 1, characterized in that at least part of the filler (18) has a color which differs from the color of the binder (16).

9. The decorative element (10, 12) for water fittings according to claim 1, characterized in that at least part of the filler (18) on its surface (30) has a colored coating.

10. The decorative element (10, 12) for water fittings according to claim 1, characterized in that the sleeve-type section is produced as a cast part, and that the surface (30) of the sleeve-type section is at least partially formed by a cast skin (32) formed by the cured binder (16).

11. The decorative element (10, 12) for water fittings according to claim 1, characterized in that the cured binder forms slight depressions between the preferably mineral filler particles.

12. The decorative element (10, 12) for water fittings according to claim 1, characterized in that the surface (30) of the sleeve-type section is formed at least in part by the particulate filler (18).

13. The decorative element (10, 12) for water fittings according to claim 1, characterized in that the decorative element (10, 12) for water fittings in the sleeve-type section has an outer peripheral surface (28) without gaps and joints.

14. The decorative element (10, 12) for water fittings according to claim 1, characterized in that the proportion of the filler (18) by weight in the sleeve-type section in the peripheral direction varies in segments of one-eighth each by less than 10%, preferably by less than 5%, and especially by less than 3%.

15. The decorative element (10, 12) for water fittings according to claims 1, characterized in that the proportion of filler particles in the radially outer sleeve half is higher by more than 2%, especially by more than 4%, than in the radially inner sleeve half.

16. The decorative element (10, 12) for water fittings according to claim 1, characterized in that the sleeve-type section has an opening (22) for the passage of part of the water fitting (1).

17. A method for producing a decorative element (10, 12) for water fittings with a sleeve-type section which is produced from a plastic, and with which the decorative element (10, 12) for water fittings can be slipped onto the water fitting (1), characterized in that the sleeve-type section is produced from a composite material by curing a polymer binder (16) with a particulate filler (18) which is incorporated thereinto.

18. The method according to claim 16, characterized in that the decorative element (10) of the device is produced by cast molding.
